(19) United States
(12) Patent Application Publication
(10) Pub. No.: US 2024/0066464 A1
(43) Pub. Date: Feb. 29, 2024

(54) METHOD AND DEVICE FOR PURIFYING POLLUTED AIR USING DRY AND WET ELECTROSTATIC TREATMENT

(71) Applicant: VAN LAER TECHNOLOGY B.V., WEERT (NL)

(72) Inventor: Hubertus Joannes VAN LAER, WEERT (NL)

(21) Appl. No.: 18/269,722

(22) PCT Filed: Dec. 24, 2021
(86) PCT No.: PCT/NL2021/050788

§ 371 Date: Jun. 26, 2023

(30) Foreign Application Priority Data
Dec. 24, 2020 (NL) 2027226

(51) Int. Cl. B01D 53/32; B01D 53/26

(52) U.S. Cl. CPC B01D 53/323; B01D 53/265; B01D 2257/406; B01D 2257/708; B01D 2257/91; B01D 2258/0266; B01D 2259/4508

(57) ABSTRACT

The present invention relates to a method for purifying polluted air containing pollutants preferably ammonia, dust, microorganisms, such as bacteria, endotoxins and viruses, wherein the method comprises the successive steps of a) introducing the polluted air to be purified into an air treatment device, b) electrostatically treating the polluted air by electrostatic charging of the pollutants contained in the polluted air, c) capturing the electrostatically charged pollutants in the air treatment device, and d) discharging purified air from the air treatment device, wherein the method further comprises the step of pre-treating the polluted air so that it has a relative humidity of preferably at least 90% and wherein the electrostatically treatment comprises the successive steps of b1) applying a dry electrostatic treatment, followed by b2) applying a wet electrostatic treatment. The invention further relates to an air treatment device for performing the method and use of such a device.

The present invention relates to a method for purifying polluted air, in particular polluted livestock stable air. The present invention further relates to an air treatment device for purifying polluted air, in particular polluted livestock stable air. The present invention also relates to a building provided with the air treatment device of the present invention. The invention further relates to the use of the air treatment device of the present invention.

Most air purification systems used nowadays are based on the principles of cyclones, liquid scrubbers and filters. Although such air purification systems do have their benefits, the yields of purification is considerably low, resulting in low levels of removal of ammonia when cyclones are used, low levels of removal of nano-particulate matter when liquid scrubbers are used or even blockage of the air stream by use of filters due to the presence of dust or particulate matter.

Several attempts have been made in the field in order to increase the yield of purification using, for example, electrostatic precipitators with limited success. Electrostatic precipitators typically used in such purification systems include (dry) electrostatic precipitators (also known as dry-ESP or ESP) and wet electrostatic precipitators (also known as wet-ESP or WESP). Both types of electrostatic precipitators have their specific advantages and disadvantages. Typically, for ESPs polluted air is introduced into the ESP, wherein the one or more electrode(s) provided by the ESP electrostatically charging to the polluted air. A grounded sidewall of the ESP will function as a collection device for charged polluted particles. However, it was found that the use of ESPs (dry electrostatic precipitators) resulted in a very low purification efficiency for ammonia compared to the known liquid scrubbing techniques. WESPs do have a similar setup as an ESP, however in addition to the setup of the ESP, in WESPs water is added near the grounded wall, in order to produce charged water flow or water droplets. It was found however that an intensive contact between ammonia molecules contained in the polluted air lacks to create the optimal condition for absorption/dissolving of the ammonia into the water droplets of the WESP.

The present invention now provides a method and a device for purifying polluted air, wherein the purification efficiency is significantly high (i.e. more than 90%). Compared to the purification systems known in the art, the present invention provides a system with significant high yields of purification. It was further observed that the method and device of the present invention provides for a high yield of purification of particulate matter, in particular nano-particulate matter.

In a first aspect of the present invention, the invention provides hereto a method for purifying polluted air, such as polluted stable air, wherein the polluted air contains pollutants, such as ammonia, dust, micro-organisms, viruses and odour of volatile organic components, wherein the method comprises the successive steps of:
a) introducing the polluted air to be purified into an air treatment device;
b) electrostatically treating the polluted air to be purified introduced in step a) by electrostatic charging of the pollutants contained in the polluted air;
c) capturing the electrostatically charged pollutants in the air treatment device; and
d) discharging purified air from the air treatment device.

It was found that a high purification efficiency can be achieved by providing the above method wherein the method on the one hand further comprises the step of, before step b), pre-treating the polluted air to be purified introduced in step a) so that it has a relative humidity of preferably at least 90%. On the other hand wherein in the present method, in step b), the electrostatic treatment of polluted air to be purified comprises the successive steps of b1) applying a dry electrostatic treatment followed by b2) applying a wet electrostatic treatment. By providing the method of the present invention the results of purification efficiency are significantly higher compared to the results of purification efficiency by using both electrostatic treatments separately. Even further it was found that by increasing (or maintaining) a high relative humidity, it was observed that the ionization and removal of pollutants, such as ammonia and/or (nano-)particulate matter, is significantly high (i.e. more than 90% removal, even with an efficiency of up to 99.9%).

Further, it was found that the combination of the above identified combinational treatment, thus combining the increase (or maintenance) of a relative humidity of at least 90% and the electrostatic treatment by applying a combination of a consecutive dry electrostatic treatment (electrostatic plasma) and wet electrostatic treatment (electrostatically charged fluid), results in a significant high efficiency of pollutant removal from polluted air.

The present invention thus provides a method comprising three processing steps, i.e. (i) regulating the relative humidity of the polluted air in order to optimise the conditions for removal of pollutants from the polluted air, (ii) treating the polluted air with an intensive, highly ionized, flow of air (electrostatic plasma), and (iii) treating the polluted air with an intensive, highly charged flow of fluid (electrostatically charged fluid). With the cascade of processing steps the method of the present invention particularly high yields of purification are observed for ammonia, dust, micro-organisms, viruses, fungal spores, endotoxins and odour of volatile organic components.

By providing the method of the present invention, it was found that the method (or device performing the method) can be applied for a permanent, e.g. continuous, recycling purification system of, for example, stable air. Recycling of stable air is in particular beneficial to reduce the ambient concentration of ammonia. However, the ammonia concentration in barns is often causing a negative impact on animal health and animal welfare. Due to the negative impact on the animals in stables by recycling stable air, current systems are discharging semi-purified stable air to the ambient atmosphere surrounding the stable. It was found, however, that the method of the present invention decreases the concentration of pollutants, ammonia in particular, to a concentration of about or less than 5 ppm. The significant decrease of ammonia in particular results in a purification method that is suitable for recycling stable air. With an efficiency of up to 99.9%, the method results in an improved livestock production performance of between 5% to 10%.

It was further found that, besides significantly reducing the concentration of ammonia in particular, further positive effects were observed by using the method of the present invention. It was found that a high level of purification of (nano-)particulate matter, such as aerosols, endotoxins, microorganisms, viruses and odour of volatile organic components was obtained with a purification level of up to 99.9%.

Regarding the method of the present invention, it is noted that the dry electrostatic treatment and, successive wet electrostatic treatment are electrostatic treatments typically performed by a dry electrostatic spraying nozzle and wet electrostatic spraying nozzle, respectively. By application of the electrostatic treatment, the pollutants in the polluted air are electrostatically charged, i.e. resulting in aerosols or water droplets being ionized for further removal from the polluted air. Electrostatically charged pollutants may include pollutants that are actually electrostatically charged or wherein the water droplet capturing the pollutant is electrostatically charged.

It was found that by providing the electrostatic treatment of the polluted air to be purified by the successive steps of applying a dry electrostatic treatment (electrostatic plasma) followed by a wet electrostatic treatment (electrostatically charged fluid) the most optimal purification efficiency was obtained, especially in reducing the concentrations of ammonia and (nano-)particulate matter in particular. As used herein, the term, “nano-particulate” means a particle having at least one dimension that is less than about 1 μm, preferably less than 500 nm, still more preferably less than 200 nm, and most preferably less than 100 nm. Further, the term “particulate matter” includes inhalable particles, with diameters that are generally 10 micrometres and smaller (also referred to as “PM₁₀”) and/or fine inhalable particles, with diameters that are generally 2.5 micrometres and smaller (also referred to as “PM_{2.5}”).

Before electrostatically treating the polluted air, it was found that a pre-treating step is beneficial in further increasing the purification results of the method of the present invention. Such a pre-treating step may be applied to the polluted air to be purified so that it has a high relative humidity, e.g. preferably between 92% and 99%. Even more preferred the relative humidity is increased or maintained during the pre-treating step between 95% and 98%. Preferably, a (non-electrostatic) fluid spraying device (such as a water spraying nozzle) is used to increase and/or maintain the high relative humidity of the introduced polluted air.

It was further found that it might be beneficial to apply the pre-treating step wherein an organic acid, such as oxalic acid, acetic acid and malonic acid, is added to the polluted air introduced into the air treatment device, e.g. via the fluid spraying device. Organic acids may be used to acidify the fluid (e.g. water) in order to increase the purification efficiency, as long as the organic acid used is not harmful to for example humans and/or other mammals, and does not causes any environmental issues.

The electrostatically charged pollutants may be captured during the capturing step c) by attracting and/or condensing the electrostatically charged pollutants. Especially the condensation of ionized electrostatically charged pollutants, such as electrostatically charged fluid, was found to be an effective method of the removal of electrostatically charged pollutants from the polluted air introduced into the air treatment device.

It was further found that the application of a high electrical voltage may be of further benefit to increase the purification efficiency. Particular beneficial results may be observed by treating the polluted air by using a dry electrostatic device at an electrical voltage of between 85 kV and 100 kV. Alternatively, or additionally, further beneficial results may be observed by treating the polluted air by using a wet electrostatic device at an electrical voltage of between 50 kV and 60 kV. It is further noted that preferably a low dose of organic acid in water (about 0.5%) is applied during the wet electrostatic treatment step.

In an embodiment of the method of the present invention step b1) may comprise the following steps of:
providing an electrostatic device coupled to an air supply and an electrical voltage power supply;
simultaneously supplying an electrical voltage of between 85 kV and 100 kV and air with a relative humidity of less than 10% into the electrostatic device in order to produce an electrostatic plasma; and
supplying the electrostatic plasma to the polluted air introduced into the air treatment device.

Also, in addition or alternatively to the above identified embodiment, step b2) may comprise the steps of:
providing an electrostatic device coupled to a fluid supply, air supply and an electrical voltage power supply;
simultaneously supplying an electrical voltage of between 50 kV and 60 kV, fluid and air into the electrostatic device in order to produce an electrostatically charged fluid; and
supplying the electrostatically charged fluid to the polluted air introduced into the air treatment device.

Regarding step b2) it is noted that the air supplied into the electrostatic device is supplied such that the fluid supplied into the electrostatic device is atomized into fine water droplets, e.g. water droplets having a water droplet size of 60 μm or less, preferably having a water droplet size of about 40 μm.

In this respect it is noted that the term “fluid” as used herein may refer to a liquid, preferably an aqueous liquid, such as water. In order to facilitate the purification process the fluid is a non-polluted fluid. For example, as a fluid supply tap water may be used as a suitable source. However, in case considered suitable, groundwater may also be selected as a suitable fluid supply. It is further noted that the electrostatically charged fluid produced by the electrostatic device may comprise electrostatically charged water vapour.

It was further found that it might be beneficial to provide a fluid supply, wherein the fluid comprises an organic acid, such as oxalic acid, acetic acid and malonic acid, i.e. the fluid being acidified with an organic acid. Organic acids may be used in order to increase the purification efficiency, as long as the organic acid used is not harmful to mammals, e.g. humans and animals, and does not causes any environmental issues.

Besides providing a method wherein a high electrical voltage is applied, a further increase in the purification efficiency may be observed in case the application of the electrostatic spraying is performed in a pulsating manner, instead of the continuous treatment of the polluted air with the dry electrostatic spraying and/or wet electrostatic spraying. Preferably, steps b) and c) are alternating relative to each other, i.e. in addition to applying an electrostatic treatment in a pulsating manner, the capturing of electrostatically charged pollutants may be performed in the same alternately pulsating manner.

The polluted air may be introduced into the air treatment device with any flow rate suitable for passing the polluted air through the air treatment device. However, a preferred flow rate of the polluted air may be between 6,000 to 18,000 m³/hour. More preferably the flow rate of the polluted air introduced into the air treatment device is between 10,000 to 14,000 m³/hour. Optimal results in purification efficiency may be observed by introducing the polluted air into the air treatment device with a flow rate of about 12,000 m³/hour.

In a second aspect of the present invention, the present invention provides an air treatment device for performing the method of the first aspect of the invention. In particular, the present invention provides an air treatment device for purifying polluted air, such as polluted stable air, wherein the polluted air contains pollutants, such as ammonia, dust, micro-organisms, viruses and odour of volatile organic components, wherein the air treatment device comprises at least one inlet for introducing polluted air to be purified and at least one outlet for discharging purified air purified in the air treatment device, the air treatment device further comprising:
a treatment unit configured to electrostatically treat polluted air to be purified; and
a capturing unit positioned downstream relative to the treatment unit configured to capture electrostatically charged pollutants in the air treatment device from the polluted air passed through the treatment unit.

As already stated above, it was found that a highly efficient purification method can be performed by providing an air treatment device of the present invention wherein the air treatment device further comprises a pre-treatment unit positioned upstream relative to the treatment unit configured to increase and/or maintain the relative humidity of the polluted air to be purified to at least 90%, and wherein the treatment unit is configured to successively apply a dry electrostatic treatment and a wet electrostatic treatment.

With regard to the relative humidity, the pre-treatment unit may be configured to increase and/or maintain the relative humidity of the polluted air to be purified between 92% and 99%, preferably between 95% and 98%.

The treatment unit of the air treatment device of the present invention may comprise a first electrostatic device coupled to an air supply and an electrical voltage power supply, wherein the first electrostatic device is configured to produce an electrostatic plasma. Further the treatment unit of the air treatment device of the present invention may comprise a second electrostatic device coupled to a fluid supply, an air supply and an electrical voltage power supply and located downstream relative to the first electrostatic device, wherein the second electrostatic device is configured to produce an electrostatically charged fluid.

Preferably, the first electrostatic device is located at a distance from the air treatment device such that the electrostatic plasma can be produced in the first electrostatic device before supplying the electrostatic plasma to the treatment device. Optionally, the second electrostatic device is also located at a distance from the air treatment device such that the electrostatically charged fluid can be produced in the second electrostatic device before supplying the electrostatically charged fluid to the treatment device. It was found that for an optimal functioning of the electrostatic treatment steps, the electrostatic device(s) are preferably located at some distance from the air treatment device. Such distance may be created by bulge shaped vaultings wherein the electrostatic plasma and/or electrostatically charged fluid can be formed in the most optimal way before supplying the electrostatic plasma and/or electrostatic water vapour to the air treatment device.

The pre-treatment unit may be configured to feed a significant amount of fluid spray (such as a water spray) to the polluted air to be purified. For example, the pre-treatment unit may be configured to feed 50 kg/hour to 70 kg/hour water spray to the polluted air to be purified. Optimal results may be obtained by feeding about 60 kg/hour water spray to the polluted air to be purified.

The capturing unit as used in the air treatment device may comprise a capturing device. Such capturing device preferably comprises a condenser. The condenser as used in the air treatment device is preferably configured to condense electrostatically charged fluid comprising pollutants, such as ammonia, dust, micro-organisms, viruses, odour of volatile organic components, fungal spores and endotoxins. Optionally, the capturing unit may further comprise a discharge conduit for discharging condensed fluid (e.g. water) comprising the captured pollutants.

The treatment unit may be configured to electrostatically treat polluted air to be purified in a pulsating manner, instead of continuously electrostatically treating polluted air. For this purpose, the treatment unit may be connected to a processing device, such as a computer, to control the frequency of the electrostatically treatment. In addition, the treatment unit and capturing unit may communicate with each other in order to perform an alternate pulsating treatment and capturing method. Preferably both the treatment unit and capturing unit are connected to a processing device, such as a computer, to control the frequency and alternating manner of the pulsated treatment and capturing of pollutants in the air to be purified.

In order to introduce polluted air into the air treatment device, the air treatment device may comprise a fan, which fan is positioned at the inlet of the air treatment device. The fan may be configured to introduce polluted air at any flow rate into the air treatment device, however, preferred flow rates include a flow rate of 6,000 to 18,000 m³/hour, preferably a flow rate of 10,000 to 14,000 m³/hour. Optimal results may be obtained by providing a fan which is configured to introduce polluted air at a flow rate of about 12,000 m³/hour.

As already mentioned above, the air treatment device may be configured to apply high electrical voltages to polluted air to be purified. In order to apply first high electrical voltages to polluted air the first electrostatic device may be configured to treat polluted air to be purified at an electrical voltage of between 85 kV and 100 kV. Further, or alternatively, the second electrostatic device may be configured to treat polluted air to be purified at an electrical voltage of between 50 kV and 60 kV.

In order to prevent any back discharge of ions from the treatment unit of the air treatment device, e.g. the electrostatic plasma produced by the first electrostatic device, towards the inlet of the air treatment device, and the subsequent release of ions from the treatment unit into the ambient air (e.g. the stable air), the air treatment device may further comprise an electron and/or ion capturing unit positioned upstream relative to the treatment unit configured to capture electrons and ions.

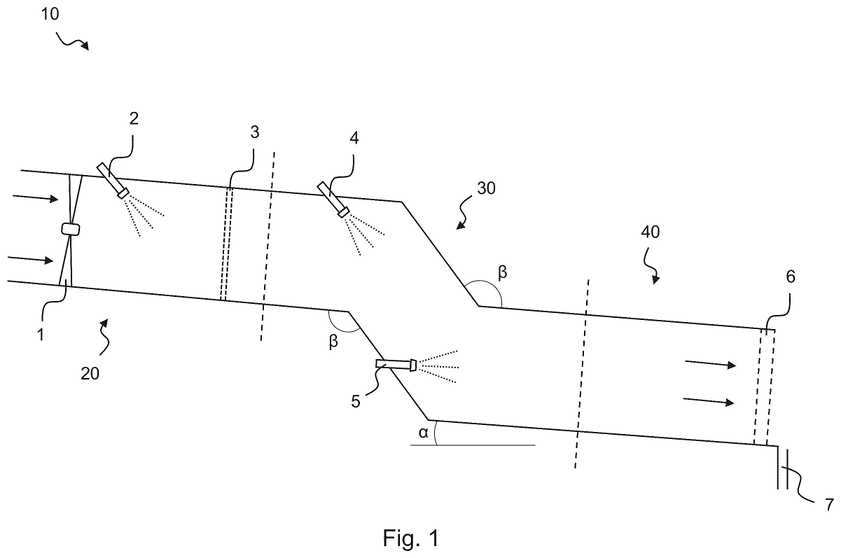

The air treatment device of the present invention may have a tubular, pipe-shaped or channel-shaped elongated extension. The extension of the air treatment device may have a round, square, rectangular, octagonal or hexagonal cross-section. It was found that by providing a Z-shaped air treatment device, in particular an air treatment device having a Z-shaped treatment unit, further optimal results in purification efficiency may be observed. So, instead of a continuous extension, an air treatment device having a kinked extension is preferred in particular. The Z-shaped portion may have an angle β (see also: FIG. 1) of between 90° and 180°. Preferably the Z-shaped portion have an angle β of between 110° and 160°, preferably about 135°.

Further, the air treatment device may inclined relative to the horizontal plane, wherein the inlet of the air treatment device is at a higher height (relative to the horizontal plane) compared to the outlet of the air treatment device. Although any inclination may be beneficial, as long as the inclination is of limited slope, a preferred inclination may be selected with an angle α (see also: FIG. 1) between 1° and 10°, preferably between 4° and 8°, preferably about 6°.

In a third aspect of the present invention, the invention relates to a building, such as a stable, hospital, school building, office building or greenhouse, wherein the building is provided with the air treatment device according to the second aspect of the invention for performing the method of the first aspect of the invention. It was found that by providing the air treatment device of the present invention, resulting in a high purification efficiency of the polluted air within the building, the purified air may be returned into the building. Therefore, the air treatment device may be positioned such that the at least one inlet and the at least one outlet of the air treatment device debouche into the building.

Alternatively, as the purification efficiency of the method performed by the present invention results in the significant reduction of, for example, ammonia and/or odour of the air purified by the air treatment device, the purified air may be released to the ambient environment. Therefore, the air treatment device may also be positioned such that the at least one inlet of the air treatment device debouches into the building and the at least one outlet of the air treatment device debouches outside the building.

In a fourth aspect of the present invention, the invention relates to the use of the air treatment device according to the second aspect of the present invention for removing pollutants, preferably ammonia, dust, microorganisms, such as bacteria, endotoxins and viruses, from a building used in the intensive livestock farming. It was also found that the air treatment device of the present invention may be beneficially used for removing pollutants, preferably microorganisms, such as bacteria, endotoxins and viruses, from a building used in the food industry and/or from a building with large amounts of people, such as a hospital, school building, office building and covered public areas. It was further found that the air treatment device of the present invention may be beneficially used for removing pollutants, preferably microorganisms, such as bacteria, fungal spores and viruses, from a building used in the greenhouse horticulture.

The present invention will be further elucidated on the basis of the non-limitative exemplary embodiments shown in the following figure. Wherein:

FIG. 1 is a schematic longitudinal cross-sectional view of a first embodiment of the air treatment device of the present invention;

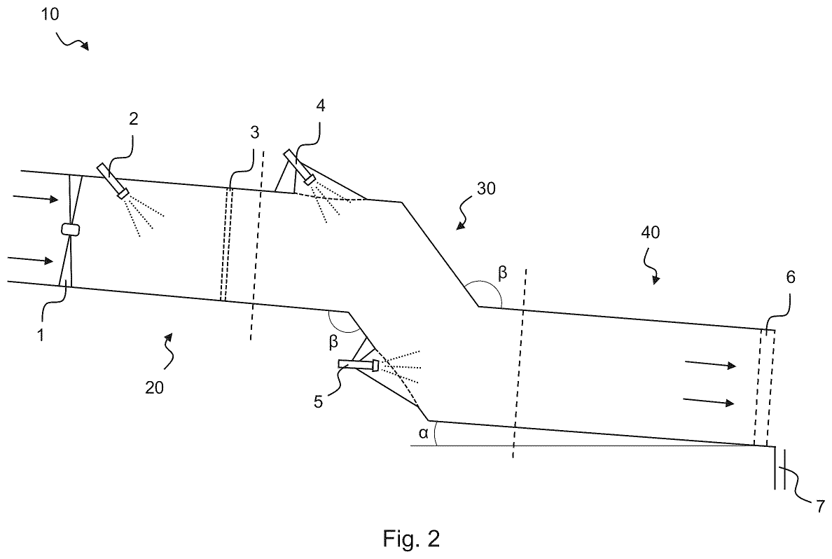

FIG. 2 is a schematic longitudinal cross-sectional view of a second embodiment of the air treatment device of the present invention;

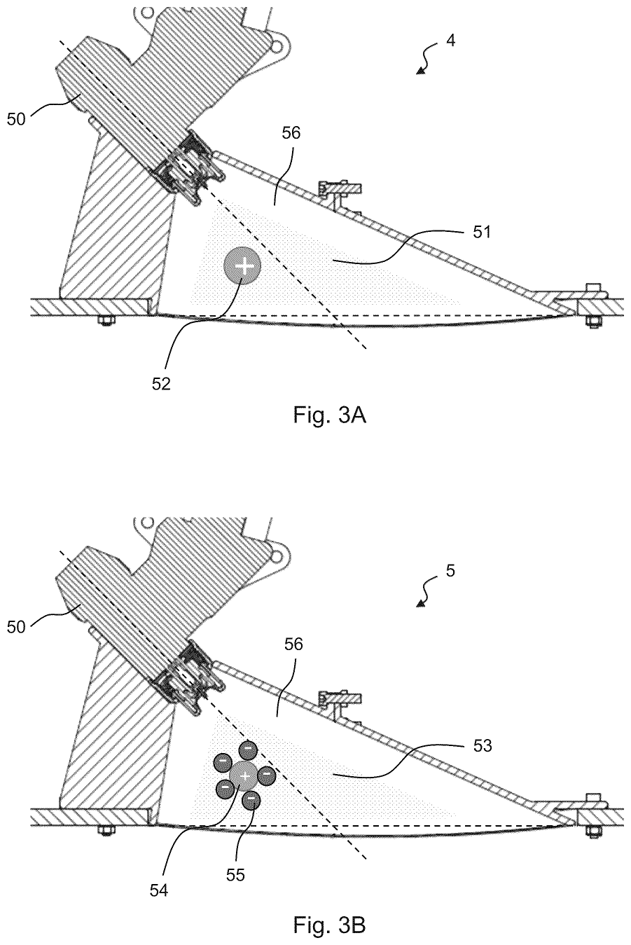

FIG. 3A-3B is a cross-sectional view of the first electrostatic device and second electrostatic device, respectively, of the present invention; and

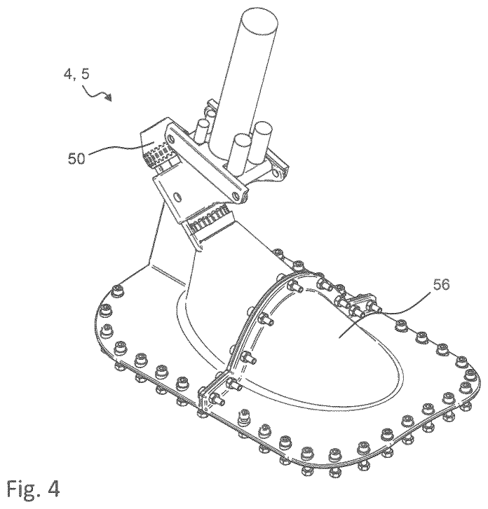

FIG. 4 is a perspective view of the electrostatic devices of the present invention.

FIG. 1 shows a schematic view of a first embodiment of the air treatment device 10, wherein the air treatment device 10 is divided into three different units, including the (optional) pre-treatment unit 20, the treatment unit 30 and the capturing unit 40. The air treatment device 10 as depicted in FIG. 1 is inclined at an angle α (about 6°) relative to the horizontal plane.

The pre-treatment unit 20 comprises an inlet for introducing polluted air into the air treatment device 10 (visualized by the arrows). In order to control the flow rate of the polluted air introduced into the treatment device 10, the pre-treatment unit 20 may comprise a fan 1. Furthermore, the pre-treatment unit 20 may comprise a (non-electrostatic) spraying device 2 to increase (or maintain) the relative humidity of the introduced polluted air to at least 90% (preferably between 95% to 98%). By providing the spraying device 2, removal of particulate matter (including the removal of PM₁₀, PM_{2.5} and nano-particulate matter) is enhanced due to the providing a sticky surface of the pollutants comprised in the polluted air. As depicted in FIG. 1, an ion capturing device 3 is positioned between the pre-treatment unit 20 and the treatment unit 30. Such ion capturing device 3 may include a so-called back discharge capturing device.

The treatment unit 30 as depicted in FIG. 1 has a kinked shape, a “Z”-shape, with an angle β (about 135°). The treatment unit 30 as depicted in FIG. 1 comprises two electrostatic devices 4, 5 (electrostatic spraying devices). The electrostatic devices 4, 5 are positioned such that in combination with the kinked shape of the treatment unit 30 an intensive mix of water particle flow and electromagnetic forces from the electrostatic devices 4, 5 is created. Preferably, the treatment unit 30 comprises a dry electrostatic device 4 (for producing an electrostatic plasma) and a wet electrostatic device 5 (for producing an electrostatically charged fluid) positioned downstream relative to the dry electrostatic device 4. By application of a dry electrostatic device 4 as a first treatment step in the treatment unit 30, ionized air is produced wherein the ammonia is ionized as well as nano-particulate matter, and organic pollutants like volatile organic components (also including CO₂). As a second step, i.e. the wet electrostatic treatment step as depicted in FIG. 1 using electrostatically charged fluid, water-soluble pollutants, like ammonia and CO₂, are removed from the polluted air.

The capturing unit 40 comprises a capturing device 6, i.e. a condenser for capturing electrostatically charged pollutants before releasing the purified air out of the outlet of the air treatment device. The capturing unit 40 further comprises a discharge conduit 7 for discharging the captured fluid and pollutants comprised therein from the air treatment device 10.

FIG. 2 shows a schematic view of a second embodiment of the air treatment device 10 which is identical to the air treatment device 10 of FIG. 1. However, both the electrostatic devices 4, 5 are located at some distance from the air flow (indicated by the arrows) in the air treatment device 10. The specific parts of the electrostatic devices 4, 5 as depicted in FIG. 2 are further shown in more detail in FIG. 3A (electrostatic device 4) and FIG. 3B (electrostatic device 5).

Both FIG. 3A and FIG. 3B depict a spraying nozzle 50 both coupled to an electrical voltage power supply (not shown). The spraying nozzle 50 of the electrostatic device 4 is further coupled to an air supply (not shown). The spraying nozzle 50 of the electrostatic device 5 is further coupled to an air supply (not shown) and fluid supply (not shown). The spraying nozzle 50 as depicted in FIG. 3A is able to produce an electrostatic plasma 51 comprising positively charged ions 52, whereas the spraying nozzle 50 as depicted in FIG. 3B is able to produce an electrostatically charged fluid 53 comprising positively charged fluid (e.g. water droplets) 54 surrounded by electrons 55. Space 56 is shaped in such form that both the plasma 51 and fluid 53 have sufficient space to be formed without intervening with the walls of the device 4, 5.

FIG. 4 shows a perspective view of the electrostatic devices 4, 5 comprising the spraying nozzle 50 and the outer side of the kind of conical shaped space 56 (e.g. bulge shaped vaultings).

1. A method for purifying polluted air, such as polluted stable air, wherein the polluted air contains pollutants, such as ammonia, dust, micro-organisms, viruses and odour of volatile organic components, wherein the method comprises the successive steps of:
a) introducing the polluted air to be purified into an air treatment device;
b) electrostatically treating the polluted air to be purified introduced in step a) by electrostatic charging of the pollutants contained in the polluted air;
c) capturing the electrostatically charged pollutants in the air treatment device; and
d) discharging purified air from the air treatment device,
characterized in that the method further comprises the step of:
before step b), pre-treating the polluted air to be purified introduced in step a) so that it has a relative humidity of preferably at least 90%; and
in that in step b), the electrostatic treatment of the polluted air to be purified comprises the successive steps of b1) applying a dry electrostatic treatment, followed by b2) applying a wet electrostatic treatment.

2. The method according to claim 1, wherein the polluted air to be purified introduced in step a) is pre-treated so that it has a relative humidity of between 92% and 99%, preferably between 95 and 98%, before electrostatically treating the pre-treated polluted air in step b).

3. The method according to claim 1, wherein, in step c), the capturing of the electrostatically charged pollutants comprises the step of electrostatically attracting and/or condensing the electrostatically charged pollutants.

4. The method according to claim 1, wherein step b1) comprises the steps of:
providing an electrostatic device coupled to an air supply and an electrical voltage power supply;
simultaneously supplying an electrical voltage of between 85 kV and 100 kV and air with a relative humidity of less than 10% into the electrostatic device in order to produce an electrostatic plasma; and
supplying the electrostatic plasma to the polluted air introduced into the air treatment device.

5. The method according to claim 1, wherein step b2) comprises the steps of:
providing an electrostatic device coupled to a fluid supply, air supply and an electrical voltage power supply;
simultaneously supplying an electrical voltage of between 50 kV and 60 kV, fluid and air into the electrostatic device in order to produce an electrostatically charged fluid; and
supplying the electrostatically charged fluid to the polluted air introduced into the air treatment device.

6. The method according to claim 1, wherein, in step a), the polluted air to be purified is introduced into the air treatment device with a flow rate of 6,000 to 18,000 m³/hour, preferably with a flow rate of 10,000 to 14,000 m³/hour, more preferably with a flow rate of about 12,000 m³/hour.

7. An air treatment device for purifying polluted air, such as polluted stable air, wherein the polluted air contains pollutants, such as ammonia, dust, micro-organisms, viruses and of volatile organic components, wherein the air treatment device comprises at least one inlet for introducing polluted air to be purified and at least one outlet for discharging purified air purified in the air treatment device, the air treatment device further comprising:
a treatment unit configured to electrostatically treat polluted air to be purified; and
a capturing unit positioned downstream relative to the treatment unit configured to capture electrostatically charged pollutants in the air treatment device from the polluted air passed through the treatment unit,
characterized in that the air treatment device further comprises a pre-treatment unit positioned upstream relative to the treatment unit configured to increase and/or maintain the relative humidity of the polluted air to be purified to at least 90%, and
in that the treatment unit is configured to successively apply a dry electrostatic treatment and a wet electrostatic treatment.

8. The air treatment device according to claim 7, wherein the treatment unit comprises:
a first electrostatic device coupled to an air supply and an electrical voltage power supply, wherein the first electrostatic device is configured to produce an electrostatic plasma; and
a second electrostatic device coupled to a fluid supply, an air supply and an electrical voltage power supply and located downstream relative to the first electrostatic device, wherein the second electrostatic device is configured to produce an electrostatically charged fluid.

9. The air treatment device according to claim 8, wherein the first electrostatic device is located at a distance from the air treatment device such that the electrostatic plasma can be produced in the first electrostatic device before supplying the electrostatic plasma to the treatment device.

10. The air treatment device according to claim 8, wherein the second electrostatic device is located at a distance from the air treatment device such that the electrostatically charged fluid can be produced in the second electrostatic device before supplying the electrostatically charged fluid to the treatment device.

11. The air treatment device according to claim 7, wherein the pre-treatment unit is configured to feed 50 kg/hour to 70 kg/hour, preferably about 60 kg/hour, water spray to the polluted air to be purified.

12. The air treatment device according to claim 7, wherein the pre-treatment unit is configured to increase and/or maintain the relative humidity of the polluted air to be purified between 92% and 99%, preferably between 95% and 98%.

13. The air treatment device according to claim 7, wherein the capturing unit comprises a capturing device, such as a condenser, and wherein the capturing unit, optionally, further comprises a discharge conduit for discharging condensed fluid comprising the captured pollutants.

14. The air treatment device according to claim 7, wherein the air treatment device further comprises a fan, which fan is positioned at the inlet of the air treatment device.

15. The air treatment device according to claim 14, wherein the fan is configured to introduce polluted air to be purified into the air treatment device with a flow rate of 6,000 to 18,000 m³/hour, preferably with a flow rate of 10,000 to 14,000 m³/hour, more preferably with a flow rate of about 12,000 m³/hour.

16. The air treatment device according to claim 8, wherein:
the first electrostatic device is configured to treat polluted air to be purified at an electrical voltage of between 85 kV and 100 kV; and/or
the second electrostatic device is configured to treat polluted air to be purified at an electrical voltage of between 50 kV and 60 kV.

17. The air treatment device according to claim 7, wherein the air treatment device further comprises an electron and/or ion capturing unit positioned upstream relative to the treatment unit configured to capture electrons and/or ions, which electrons and/or ions move from the treatment unit towards the inlet of the air treatment device.

18. A building, such as a stable, hospital, school building, office building or greenhouse, characterized in that the building is provided with the air treatment device according to claim 7.

19. The building according to claim 18, wherein the air treatment device is positioned such that the at least one inlet and the at least one outlet of the air treatment device debouche into the building.

20. The building according to claim 18, wherein the air treatment device is positioned such that the at least one inlet of the air treatment device debouches into the building and the at least one outlet of the air treatment device debouches outside the building.

21. A use of the air treatment device according to claim 7 for removing pollutants, preferably ammonia, dust, microorganisms, such as bacteria, endotoxins and viruses, from a building used in the intensive livestock farming.

22. The use of the air treatment device according to claim 7 for removing pollutants, preferably microorganisms, such as bacteria, endotoxins and viruses, from a building used in the intensive livestock farming, in the food industry and/or from a building with large amounts of people, such as a hospital, school building, office building and covered public areas.

23. A use of the air treatment device according to claim 7 for removing pollutants, preferably microorganisms, such as bacteria, fungal spores and viruses, from a building used in the greenhouse horticulture.
